(19) United States
(12) Patent Application Publication
(10) Pub. No.: US 2026/0039778 A1
(43) Pub. Date: Feb. 5, 2026

(54) SPATIAL COMMUNICATION SYSTEM

(71) Applicant: Adam Wacey, London (GB)

(72) Inventor: Adam Wacey, London (GB)

(21) Appl. No.: 19/287,940

(22) Filed: Aug. 1, 2025

(30) Foreign Application Priority Data
Aug. 5, 2024 (GB) 2411487.8

(51) Int. Cl. H04N 13/161; G06F 3/16; G06T 7/194; H04N 13/204; H04N 13/305; H04N 13/388

(52) U.S. Cl. CPC H04N 13/161; G06F 3/16; G06T 7/194; H04N 13/204; H04N 13/305; H04N 13/388

(57) ABSTRACT

A method and apparatus for an imaging system capturing light field image data and audio data that is compressed and transmitted over a heterogenous network to the plurality of users. The video data is decompressed to volumetric frames and this data is rendered in a computer synthesised 3D environment employing a volumetric lenticular hardware display to engage foveal vision and a secondary display to engage peripheral vision. This depth enhanced, real-time communication system, is highly amenable for use in Telepsychiatry applications.

### CROSS-REFERENCE TO RELATED APPLICATION

This application claims the benefit of UK Patent Application No. GB 2411487.8, filed Aug. 5, 2024, the content of which is incorporated in its entirety.

### FIELD OF INVENTION

The present invention relates to apparatus, methods and systems for real-time spatial communication. In particular embodiments of the invention relate to real-time communication systems to capture and transmit both live and recorded 3D, light field media, for spatial display in real-time.

### BACKGROUND

Video conferencing devices and software allow simultaneous viewing of a subject whilst talking, thus providing a more nuanced and complete interaction than audio alone. Whole classes of non-verbal communication and visual cues, including those projected by body language, facial expressions and gestures are available to augment understanding derived from the audio stream. In particular, during a face-to-face conversation, people draw meaning from head and eye movements, which help to signal turn-taking, agreement, and a host of affective cues (Kleinke 1986). Video conferencing technology more closely mirrors the complexity of in-person communication and these benefits are immediately appreciated by participants.

The technology underlying modern video conferencing has been steadily evolving for nearly a century. In April 1927, a landmark communication took place between US Secretary of Commerce, Herbert Hoover in Washington D.C. and AT&T® President, Walter Gifford at AT&T's® Bell lab's headquarters in midtown Manhattan. Hoover's live, moving image and voice were transmitted over ˜200 miles of telephone line to be seen by both Gifford and an invited audience comprising several dozen newspaper reporters and Bell officials. The audio stream was Duplex (two way), and the video Simplex (one-way), so that only those in New York were able to see the live, remotely captured video. This first demonstration of Video Conferencing was in some ways accidental, in that, the technology was intended to eventually serve as medium for Television. However, broadcast TV, transmitted over the airwaves soon proved a superior technology, forcing AT&T® to abandon their project. Extraordinarily, the general public were then almost immediately introduced to the concept of video conferencing en masse when a large screen video telephone system featured prominently in Fritz Lang's prophetic film, Metropolis, premiering in September 1927. Thus, video conferencing entered the public consciousness far before workable example of these devices were generally available.

Some 30 years later, AT&T® would return to researching video conferencing, in its own right, so that in 1964, they would unveil the Picturephone, an audio telephone with full duplex, synchronised, video streaming, at the New York World's fair. On this later occasion, the public was invited to place video calls both between devices located in the fairground and a further, geographically more remote device, located at Disneyland in California. This limited beta test of video conferencing technology was deemed successful and in 1971 AT&T® would commercially release their Picturephone II to major markets in the U.S.A. However, the extraordinary rental cost of each system, at around $950 per month (in 2024 dollars), plus billing of $150 per minute of use, meant that the entire network comprised only around 500 subscribers and in 1973 the project was discontinued.

The dotcom boom of 1993-2001, provided the funding to build a general-purpose, globe spanning, IP networking infrastructure that communication hardware vendors would subsequently use to deliver specialist video conferencing devices to a broad and geographically diverse audience. By the time of the dot com bust, modern computers would also have enough processing power to compress media captured from a consumer web camera in real-time and at reasonable frame rates. This compressed video and audio would be sufficiently compact to be suitable for transmission over a modern IP network connection. Simultaneously, Internet Service Providers had also been relentlessly expanding their bandwidth so the network capacity to both transmit and receive video was now more available. Thus, both hardware and network requirements were in place to allow video conferencing to achieve a critical mass in consumer adoption.

Skype® was launched in 2004 and proved an immediate success. It's simplicity of interaction and free download removed any resistance from users to try the software. Families, scattered across the world could stay in touch through personal video calling and businesses now had a mechanism to allow remote workers to collaborate in a rapidly globalising commercial environment. Soon Skype® would become a virtual monopoly and the application's name synonymous with video calling in general. As such, Skype® users would experience the beneficial aspects of Metcalf's effect (the usefulness of a network is proportional to the square of the number of connected users), as all the user's potential contacts would have a Skype® handle and a downloaded and online version of the software available across their many devices.

In 2010 Skype® was acquired by Microsoft® whilst numerous competitors in the video conferencing and collaboration ecosystem launched into the market (Cisco's Web-Ex® and Zoom® being notable examples). The application and technology had clearly “crossed the chasm” to general consumer acceptance.

In March 2020 COVID-19 struck. Innumerable societal functions were forced into online video communication, primarily employing consumer grade video chat applications from home computers on videoconferencing platforms that had developed over the last decades, as described above. Zoom®, jumped from around 10 million users in December 2019, to more than 300 million users some 5 months later (Iqbal 2020). Both the platforms hardware/software and underlying networks proved equal to the tasks at hand, so that these technologies provided a timely and much-needed medium for communication between groups of all sizes whilst preserving social distancing and in doing so forged a new set of societal norms, e.g. large scale working from home engendering remote provision of services.

The mass adoption of video conferencing during the COVID-19 pandemic, in some ways, acted as an experimental validation of these platforms, in which the sheer number of participants revealed the successes and failings implicit to the technology. The most commonly reported problem was named “Zoom® fatigue”, a colloquial term describing a collection of physical and psychological responses derived from spending extended periods of time in a videoconferencing platform. Neuroscience goes some way to explaining this syndrome since on video calls, brains are more taxed than interactions in real life, as everyone is constantly watching one another. Moreover, the size of their faces on the screen gives an impression of participants being near to and this physical closeness is interpreted as an intense situation, both similar to moments of interpersonal disagreement or contrarily being drawn into a close or romantic moment. It is the avoidance of this intensity that makes people avert their eyes in enclosed spaces. In video meetings, the sensation of constantly being watched or wanting to avoid this intensity is a contributing factor to Zoom® fatigue.

Telepsychiatry is the remote provision of psychiatric healthcare through information and communications technology, including such services as diagnosis, medication management, therapy and follow-up (Achtyes et al. 2023). Initial attempts at establishing remotely delivered psychiatric care were pioneered from 1959 by the Nebraska Psychiatric Institute, using two-way CCTV to provide training to medical student at the nearby Nebraska State Hospital. The first system for clinical use was established in the early 1970s, when a two-way CCTV system was installed between this teaching hospital and a smaller rural clinic in Nebraska, Patients still went to the clinic, sat in a waiting-room and were shown into their consultation by a member of staff, who remained present during the session (Wittson 1972). This programme was a success, and a number of similar programmes were subsequently developed, (Dwyer 1973; Murphy 1974; Dongier 1986), However, prior to the Covid-19 Pandemic, despite technical maturity, use of Telepsychiatry was surprisingly limited, e.g. a study of ˜200,000 patients in 2017 found the rate of telemedicine encounters to be just 0.7% (Morreale et al. 2023).

During the COVID Pandemic, Mental healthcare practitioners and patients alike were forced to rapidly adapt to Telepsychiatry delivered through consumer video conferencing applications. Concomitantly, it's utilization dramatically increased, achieving near ubiquity by the end of 2021 (˜98%, American Psychiatric Association, 2021), and today Telepsychiatry is now routinely used to remotely perform many of the standard functions of Psychiatry.

Post COVID and in light of this newfound importance, multiple academic studies have assessed the reliability and efficacy of Telepsychiatry in both rural and urban populations and these studies have found that it provides unparalleled convenience for both Patient and Clinician whilst being highly clinically effective. Identified advantages include; reduced travel time for Patients, reduced time away from work to attend appointments, access to mental health specialty care that would otherwise be unavailable (e.g., in rural areas), increased feelings of safety for the Clinician while evaluating violent patients, reduction in infection risk, increased ease of lip reading (R. Sheriff et al 2022), greater ease of consultation for those with mobility issues, improving continuity of care and follow-up, reduced treatment delays and lowering the stigma barrier of attending sessions in person.

However, qualitative studies have also allowed Psychiatrists to express concerns about the possible drawbacks of Telepsychiatry including the fact that communication through a small 2D video screen inhibits the ease of building the therapeutic alliance and difficulty reading nonverbal communications. Most critically, patients described struggling to ‘open up’ to ‘a stranger talking over a screen’ (Biddle et al. 2023), commenting ‘I feel like we don't really know each other as well as if it was in person’. Similarly, practitioners questioned whether it was possible to establish and maintain comparable relationships to those built offline, since the technology does not fully capture the richness of in-person interaction (Biddle et al. 2023). The medium is disrupting the therapeutic relationship causing a difficulty establishing a therapeutic alliance due to the “unreality” of that medium. Further, a session is more likely to be rewarding when the technology is simple to use and works seamlessly and it is for this reason that medical devices tend to be single use appliances rather than a multi-purpose computer or mobile phone, then shoehorned into being a video conferencing device, as has historically been the case with Telepsychiatry.

It would be advantageous to overcome the problems inherent in legacy Telepsychiatry, described above, whereby the medium becomes invisible so that users experience a more authentic and complete communication, akin to that achieved in face-to-face meetings and the tech giants have spent $10's billions attempting to mimic intimacy of face-to-face meeting through Virtual Reality (VR). Meta®, Apple® and Microsoft® and a host of smaller imitators have followed each other, and VR now dominates the spatial computing “mind share”. This restricted Overtone window of technical approaches has encouraged the tech giants to double down on developing a new generation of Head Mounted Display (HMD) hardware; Apple's Vision Pro®, Microsoft's Holo-lense II© apparatus again follow a herd like approach of piling ever more hardware and processing virtuosity into each HMD, concomitantly these machines are now prohibitively expensive. But this approach is fundamentally flawed, since however sophisticated these HMD's may get, the bulky, ever-more power-hungry wearables sit on user's faces, an appalling form factor for communication, inducing motion sickness, eye fatigue, disorientation and nausea in some 33% of consumers (Chang et al 2020). This discomfort can only be worse for those undergoing a mental health crisis. Further, we argue that the synthetic and literally disembodied nature of avatars used in the Metaverse, is far inferior to the authentic, live and constantly, subtly changing projection of the self, captured via streaming video.

### SUMMARY OF INVENTION

According to one aspect of the invention there is provided an apparatus for real-time spatial communication. The apparatus comprises a lenticular display for displaying the subject during real-time spatial communication. The apparatus further comprises a secondary display positioned with a viewing surface behind the lenticular display for displaying a background image.

In another aspect of the invention, there is provided a method of real-time spatial communication. The method comprises capturing 3D volumetric video of a scene at a first location; transmitting the 3D volumetric video over a network; and receiving the 3D volumetric video from the network at a second (remote) location. The method also comprises rendering the 3D volumetric video simultaneously as a 3D subject on a lenticular display and a background on a secondary display.

According to a further aspect of the invention there is provided a real-time spatial communication system. The system comprises an imaging system comprising a plurality of stereo imaging sensors configured to capture video data comprising a plurality of plenoptic frames of a scene. The system further comprises a display system comprising a lenticular display. The system also comprises an image processing system comprising a processing unit, a computer readable memory, and a network interface. The processing unit is configured to: receive captured video data from the imaging system, encode the captured video data and transmit the encoded captured video data via the network interface and receive remote video data from the network interface; decode the remote video data and display spatial video on the display system.

In another aspect of the invention there is provided an apparatus for real-time spatial communication for use in Telepsychiatry and remote therapy, the apparatus comprising a lenticular display for displaying the subject during real-time spatial communication. The communication system may further comprise a secondary display positioned with a viewing surface behind the lenticular display for displaying a background image.

It is the applicant's intention in embodiments of the invention to exploit the physical and psychological effects (mentioned above) which are believed to contribute to so called Zoom® fatigue. In particular embodiments seek to providing a depth based spatial experience employing multiple screens, increase the perceived “space” within which the participants operate to lessen both the cause and effects of Zoom® fatigue.

By employing further findings from Neuroscience we may contrast how the Brain's perceptive cues may be processed by in person meetings in comparison to video conferencing. These observations then allow us to design our own video conferencing platform that shall deliberately engage those cues to more closely mirror in person meetings than that achieved by legacy videoconferencing platforms. To wit, the dorsal processing stream (top of brain) and ventral stream (bottom of brain) originate from a common source in visual cortex. A useful rule of thumb summarises that the dorsal stream is responsible for analysis of motion while the ventral stream identifies objects, including human faces—invariably the main subject in a video conference.

The dorsal stream is involved in spatial awareness and guidance of actions (e.g., reaching). In this aspect it has two distinct functional characteristics—it contains a detailed map of the visual field and is also good at detecting and analysing movements through motion perception to infer the speed and direction of elements in a scene. This later analysis is based on visual, vestibular and proprioceptive inputs. We contend, that by deliberately stimulating motion perception using a plurality of novel 3D depth ques we may achieve a more lifelike video conferencing experience since more of the dorsal stream neural processing inputs activated in real life meetings are engaged in comparison to the dorsal stream quiescence of legacy 2D conferencing systems. Further it is our intention in some embodiments of the system to employ a further screen distal from the lenticular display in the visual processing “background” of the system. This panoramic background shall contain moving objects and lights to enhance motion perception (in actual, physical 3D space).

Within the ventral stream, the parahippocampal place area (PPA) is located in the posterior parahippocampal gyrus. The PPA is associated with visual processing of buildings and places, as patients who have experienced damage to the parahippocampal area demonstrate topographic disorientation and are unable to navigate familiar and unfamiliar surroundings (Habib & Sirigu, 1987). Outside of visual processing, the parahippocampal gyrus is involved in both spatial memory and spatial navigation (Squire & Zola-Morgan, 1991). Further, the fusiform face area is located within the inferior temporal cortex in the fusiform gyrus of the ventral stream. Similar to the PPA, the FFA exhibits higher neural activation when visually processing faces. Some research suggests that the development of the FFA and the PPA is due to the specialization of certain visual tasks and their relation to other visual processing patterns in the brain. In particular, existing research shows that FFA activation falls within the area of the brain that processes the immediate field of vision, whereas PPA activation is located in areas of the brain that handles peripheral vision (Levy et al., 2001). This suggests that the FFA and PPA may have developed specializations due to the common visual tasks within those fields of view. Thus, we contend that by deliberately stimulating both faces in the immediate field of vision and then location in a separate screen in the peripheral vision that we may once again induce a more “real-life” conferencing experience as more of the processing pathways that are animated during a real-life meeting are active.

In embodiments of the invention the secondary display may be larger than the lenticular display. The secondary display may be a panoramic display (for example having a wide screen or ultra wide screen format). The secondary display may be a curved display. A curved display has a concave viewing surface. The lenticular display may be aligned with a central axis of the viewing surface of the secondary display.

Embodiments may further comprise an audio system. The audio system may include least one speaker for outputting audio and, may for example include multiple speakers (for example a stereo or spatial audio array). The audio system may include at least one microphone for capturing audio and may, for example, include a plurality of microphones to enable stereo and/or spatial audio capture.

Embodiments may further comprise an imaging system for capturing video data. The imaging system comprises a plurality of stereo imaging sensors configured to capture a plurality of plenoptic frames of a scene. The imaging system may comprise at least one time of flight sensor for capturing a 3D point cloud. The imaging system may comprise at least one structured light sensor, for example an infra-red structured light sensor. In embodiments the imaging system may comprise a plurality of stereo cameras each stereo camera comprising a pair of cameras (for example spaced apart synchronised cameras) with a single output (for example a single USB cable).

The plurality of imaging sensors may be arranged as an array, for example a linear array. The linear array may comprise a plurality of sensor arranged along a common axis in one dimension. The array may be arranged in a convergent shape for example an arc when viewed from another axis (for example around a field of view). In embodiments the individual imaging sensors may be angled such that their frame's centroid hypotenusal distance to the observed subject is as similar as possible. The imaging sensors may be spaced apart along a housing of the apparatus. In an embodiment, the array may, for example, extends along an edge of the secondary display (for example along an upper edge of the display and may for example share a common housing).

Embodiments may further comprise an image processing system comprising a processing unit, a computer readable memory, and a network interface. The image processing system may for example be a personal computer. The processing unit may be configured to receive remote video data from the network interface, decode the remote video data and display spatial video on the lenticular display and the secondary display. The imaging system may be configured to render a 3D volumetric scene on the lenticular display and a background scene (for example a panoramic scene) on the secondary display. The background scene may be extracted from a volumetric scene based upon (RGBD) pixels having a depth value which exceeds a selected threshold value.

In embodiments capturing 3D volumetric video may comprises capturing 3D volumetric video using an array of stereo sensors. The 3D volumetric video may comprise data from a plurality of stereo sensors forming the array.

In embodiment the step of extracting background from the 3D volumetric video may comprise extracting pixels having a depth value which exceeds a threshold value.

Methods of embodiments may further comprise the step of encoding the 3D volumetric video prior to transmission over the network. The encoding step may comprise arranging frames of 3D data in a specific geometric pattern on a single 2D frame. A 2D video compression algorithm may be used to encode the resulting data. Embodiments may further comprise encapsulating the 3D volumetric video data using a virtual web camera adaptor. Transmitting the 3D volumetric data may comprise transmitting the data using a communications protocol for 2D media data.

Rendering a 3D subject on a lenticular display may comprises rendering a fan of frames each rotated about the subject by an incremental angle. The method may further comprises generating synthetic frames at intermediate angles between the captured frames. A higher density of synthetic frames may be generated in a central arc of the 3D subject than those towards the outer angles of the display arc on the lenticular display.

Rendering 3D volumetric video in embodiments may further comprise constructing a 3D model from the pixels of the volumetric video. Embodiments may comprise using a virtual camera to required views for rendering.

A real-time spatial communication system of embodiments may comprise a display system having a secondary display and wherein the image processing system may be configured to render a 3D subject scene on the lenticular display and a 2D background scene on the secondary display. The image processing system may be configured to encapsulate the captured video data from the plurality of imaging sensors as a virtual web camera. In embodiments, the image processing system may geometrically arrange RGBD data derived from the imaging sensors into a 2D frame. The image processing system may compress the video data for transmission by geometrically arranging 3D video data on a 2D frame prior to application of a 2D video compression algorithm.

An aspect of the invention may provide a real-time spatial communication system. The system may comprise a plurality of stereo imaging sensors which provides a plurality of Plenoptic frames of a scene. The system may further comprise a display system, comprising a Lenticular display. The system may further comprise an image processing system, comprising: a processing unit, a computer readable memory, and a network interface. The image processing system may be configured to encapsulate the imaging sensor in a software adapter that displays the API of a web camera to provide a virtual web camera, wherein the virtual web camera, upon receiving program control information from the communication application module, the virtual web camera initiates a mechanism to start streaming Plenoptic video data from the imaging sensor across the network to a remote partner receiving application which rends the Plenoptic images in a Lenticular display.

In embodiments, the display may comprise a lenticular display and a secondary display larger than the lenticular display. The image processing system may be configured to ingest, construct and render a panoramic display on the secondary display from the plurality of stereo imaging sensors. The secondary display may show dynamic/moving content.

The imaging sensor may comprise a capture device employing any combination of LIDAR, binocular stereo or structured light devices.

The image processing system may be further configured to compress the 3D video data for streaming by using a 2D video compression algorithm to compress frames of Plenoptic 2D data in which the pixels have been geometrically arranged into a 2D frame.

The image processing system may geometrically arrange panoramic data into a 2D frame prior to compression.

The image processing system may geometrically arrange RGBD data derived from a stereoscopic structured light camera into a 2D frame prior to compression.

In embodiments synthetic Plentoptic views from the camera are constructed prior to rending on the Lenticular display. The synthetic plentoptic views may be constructed by projecting ingested views in a games/graphics engine and adjusting the engines virtual camera extrinsic parameters to match those desired by the synthetic view, prior to rending into virtual space, wherein they may be copied into the rending Lenticular display.

The views, prior to being rendered on the Lenticular display may be upscaled via Deep learning super resolution.

The real-time volumetric video communications system of embodiments may be employed in Telepsychiatry.

The applicant, has taken a different approach from the tech giants building a unique and entirely novel video chat system using 2.5D Holograms rendered into lenticular displays—3D cube screens that sit on the desk. These systems are not claustrophobic, not vertigo inducing, can be seen from many angles and can be seen by more than one person simultaneously. The system provides a more realistic experience, it's like having the person in front of you, in 3D but contextualised by a periphery of the real world and unencumbered by bulky headsets strapped to the face. It is our contention that employing such a system provides a “spatial computing” experience, bringing participants closer together in a remote interaction replete with 3D visual and audio cues to enhance the authenticity of the conferencing experience. We also contend that employing this technology in Telepsychiatry should equally lead to better communication and thus better therapeutic outcomes in comparison to 2D legacy platforms, as the medium melts away and therapeutic bond forms.

The applicant's initial technology is protected by a granted U.K. Patent (GB2582251B), and it is our intention to progress this technology and then apply it in Telepsychiatry, overcoming problems inherent within both the VR, legacy platforms as described above but also overcoming the limitations of our initial system. The principal cause of these limitations in our own apparatus, derive from the fact that to date, we have captured depth video, often called 2.5D or RGBD video, from a conic Field of View and from a single initial viewpoint, rather than a plenoptic view of the scene—capturing all the light, travelling in every direction, in a given space.

Technical solutions to capture 2.5D video in real-time are relatively well known to one skilled in the art. 2.5D information is often represented in computer science applications as a cloud of points projected into 3D computer space, with each point being a pixel with values in the X, Y and Z axis. These point clouds can be generated by a number of physical modalities. An example of one these modalities is a Time Of Flight (T.O.F.) camera, which measure the time it takes for a discrete, physical “unit” to be transmitted and then reflected back to the transmitter/receiver. Sound based TOF cameras are cheap to purchase and thus popular in the hobbyist robotics community. However, they only operate over very short distance (typically <1 m), they are thus usually only employed to help moving robots avoid scene clutter.

A further version of the TOF cameras employs LASERs. These cameras are known by the acronym LIDAR (li[ght]+d[etecting] a[nd]r[anging]). Powerful LIDAR units, able to overcome the “noise” of the environmental background spectra, employ dozens of individual LIDAR transmitters/receivers rotating on a mechanical puck. These units have been used to successfully map the 3D environment as a point cloud in autonomous cars. However, these units are costly and so are economically unsuitable for a mass market and have a horizontal resolution limited by the number of mechanical pucks.

A further modality to produce 3D point cloud data is found in stereo disparity images calculated from two (or more) imaging sensors. In 1838 Charles Wheatstone demonstrated that the two different image planes received by a viewer's eyes are processed into a single, three dimensions view. Stereoscopic photography exploits this quirk to create the illusion of a 3D scene: a pair of 2D images are captured, where both images represent a perspective on the same scene, each a minor deviation equal to the perspectives that both eyes naturally receive in binocular vision. Similarly, computer generated 3D scenes may also be calculated by employing a variant of Wheatstones' binocular effect. In this stereo mechanism frames from two cameras are ingested and the parallax effect of binocular vision is used to calculate the disparity of each pixel between the two frames. In the most common configuration, objects that are closer will be more separated in the camera streams than those that are further away. Thus, it is possible to calculate the depth (Z plane) of each pixel shared by both frames to yield a pronounced 3D point cloud of the camera views.

Dual sensor stereo cameras utilising the principle of stereo disparity imaging as described above have found popular application in both robotics and the self-driving car communities. In these cameras, the imaging sensors are typically separated by a few centimetres (mimicking human intra ocular distance) and are synchronised to capture their images within a few milliseconds of each other (it is vital to match pixels in images that are from the same scene rather than two different scenes separated by time). Typically, each image undergoes rectification, in order to compensate for optical and mechanical differences between the two sensors and the difference between the location of patches of pixels in each image is calculated to infer each pixel's location in the depth plane.

A final type of TOF Camera employs structured light. Cheap, mass market, Infra-red structured light sensors are relatively common and have proven very successful in providing user interfaces for gaming consoles. These modalities are demonstratively impractical for an outside environment due to their poor range (<5 m) and because the infrared signal that they employ is lost in the noise of the daylight spectra of outside environments. However, as a device to capture 3D points clouds in real-time for communication that will occur indoors, they are highly practical.

The most modern version of devices tuned to capture 3D point clouds, that are provided by commercial vendors (e.g. Intels' Real Sense camera range), utilise more than one of the techniques described above. In particular, structured light is used to provide a very accurate but relatively low-resolution volumetric image onto which a higher resolution, but lower Z plane accuracy stereo camera data is mapped.

The process of converting the raw data captured by the sensor into a 3D frame of point cloud data is highly compute intensive. It can occur on the camera itself (at the edge), in which case complete 3D frames from the camera are streamed to an ingesting image processing engine. In this case, the camera is likely to employ specialist processing hardware to have the necessary compute speed, matched with relatively low power consumption, to achieve this end. Alternatively, the camera may pre-process only some of the data and provide separate streams of depth and RGB/Luminance pixels. The ingesting image processing engine then processes the separate data streams into a single 3D frame. This mechanism is less computationally expensive to the camera than processing all the data on the edge, but this computation is shifted onto the image processing engine of the ingesting computer. However, since the image processing engine ingests multiple, separate, data streams, this architecture is more flexibility in its potential applications. Finally, the camera may have little to no pre-processing and may provide only raw data streams to be ingested and processed by the image processing engine. The full burden of computation is shouldered by the image processing engine and so these cameras are concomitantly simple.

To one skilled in the art it is clear that a wide variety of technical devices are available to capture 2.5D video in real-time, yet all suffer from the same disadvantage, in that, they consume data from a highly restricted initial viewport—the correct rending of the conic 3D Field of View breaks down as the viewer moves further away from this original viewport, since in real life objects that were previously hidden by the foreground are revealed, whereas in the synthetic 3D renderings of the pixels large empty areas of space open up. Simultaneously, errors caused by pixels misattributed to their true locations in the Z plane become ever more pronounced and jarring in the changing viewport. Finally, rays of light received from highly reflective materials will differ between the original viewport and the new. This effect is particularly pronounced when moving between viewports reveals high luminance areas (e.g. point lights), in reflections from mirrors and glass. Thus, it is simply not possible to convincingly extrapolate a view of a scene that is very far from the initial viewport, since creating this synthetic view never captures the unknowable and dynamic complexity of the reflective surfaces and changes in ambient light.

The last decade has seen the development of mechanisms to capture a more complete, 3D views of a scene, that do not suffer from the failings of 2.5D video described above. These Lightfield technologies attempt to capture a vector function describing both the intensity of light in a scene and the precise direction that the light rays are traveling in space. Efforts to capture these vectors employed so-called “Plentoptic” cameras. In their simplest embodiment a Plenoptic camera places a lens array prior to the camera's image capture plane. The same effect can also be achieved by collating data from an array of synchronised cameras. The resultant data can be re-focused into a plurality of 2D images each with different focal planes and different viewports (the data is implicitly stereoscopic). Though these cameras never achieved the commercial success required to maintain a market presence, they successfully and often very beautifully, demonstrated capturing a scene in true 3D was possible. It is our intention to employ an array of cameras acting in concert to capture a light field of true 3D video, thus overcoming the implicit restrictions of 2.5D TOF cameras described above.

Standard 2D video streams are voluminous, consuming large quantities of data even at relatively low resolutions. Capturing and transmitting from a Plenoptic array of cameras concomitantly increases the overall volume of data captured and thus dramatically increases the size of the network connection required to transmit this data by a video conferencing application. This problem is further aggravated by the observation that IP Network connections speeds often differ between download and upload pipes; the network is optimised for the most common tasks, thus favouring scenarios where content is downloaded. This further inhibits the network's capacity for video conferencing application uploading large volumes of content. It would thus be advantageous to be able to transmit lower resolution images across the network, since less network bandwidth would be used. However, this scenario would result in the remote user observing lower resolution images from the smaller video stream. Classical Computer Vision does provide mechanisms whereby the smaller images received by the remote system could be upscaled, but these mechanisms only increase the overall dimensions of the image and do not match the required increase in information density for the image shown, so that the resized image becomes “blocky” and artifacts manifest, to produce highly unsatisfactory views. Recent advances in Deep Learning have provided an effective mechanism to upscale the information content of the resized view to match its new scale, these mechanisms have the collective name of Super-Resolution. It is our intention to employ Super-Resolution techniques at the remote host to upscale the received video stream, which in turn allows us to employ multiple cameras in a Plenoptic array to capture 3D video data, whilst still uploading video streams within a restricted data rate.

In summary, it is our intention, to create a tailored, Telepsychiatry platform that shall overcome the limitations of the extant crop of general-purpose technologies, shoehorned into service as Telepsychiatry applications. We shall achieve this end by designing and building a single use Telepsychiatry Appliance employing a unique, novel, Plenoptic video streaming technology stimulating multiple pathways of visual processing. The device shall provide both remote parties with high resolution, holographic video communication, emulating face-to-face meeting, dissolving the inhibitory medium to establish stronger rapport between Clinician and Patient. We shall also design a partner cloud based, networking infra-structure to facilitate secure and robust video and data streaming, whilst acting as an adaptor into a Telepsychiatry administrative infrastructure. Accordingly, the apparatus, method and system of embodiment may be a real-time spatial telepsychiatry communication apparatus, method and/or system.

### BRIEF DESCRIPTION OF THE DRAWINGS

Embodiments of the present invention will now be described by way of example only and with reference to the accompanying drawings where like parts are provided with corresponding reference numerals in which:

FIG. 1 provides a block diagram of an imaging system for capturing Plenoptic image data and audio data and for integrating this video and audio stream into a 3^{rd} party communications application's conventional 2D video data to be transmitted to a plurality of users to facilitate video conferencing. Simultaneously, the Plenoptic data is laid out in computer memory and encoded to a compressed bitstream and transmitted over a computer network to a (plurality of) user(s). The receiving users may then decompress and decode the compressed Plenoptic stream to the original views and this data is rendered in a volumetric lenticular hardware display thereon, in accordance with an embodiment of the present disclosure;

FIG. 2 provides a block diagram of different geometric arrangement of stereo synchronised camera sensors to capture and ingest a Plenoptic view of a scene suitable for processing in an imaging system for rending on a lenticular display or transmission to a remote host as a means to enable that remote host to rend the scene on its own lenticular display, in accordance with an embodiment of the present disclosure;

FIG. 3 provides a block diagram to show a possible arrangement of displays in embodiments of the present disclosure, wherein stereo synchronised cameras are geometrically arranged above a 2D panoramic wide screen display and in front of which a lenticular display is placed, in accordance with an embodiment of the present disclosure;

FIG. 4 provides a block diagram of a method to encode stereo synchronised camera frames that enables a 2.5D RGBD disparity frame to be derived from these “real-world” frames by binocular image processing. The block diagram further demonstrates how a virtual camera view onto this RGBD disparity frame located in 3D computer space may then rotated to create further synthetic frames between the original camera frame and the central disparity frame. This fan of interleaved captured/synthetic frames, each separated by an equal rotation may then be rendered into a lenticular display to yield a continuous 3D view rotating about the subject, in accordance with an embodiment of the present disclosure;

FIG. 5 provides a block diagram of the software modules (boxes), Application Programming Interfaces (circles for interfaced module, half circles for interfacing module), communication channels (arrowed lines) and network architectures (hashed boxes), employed in transmitting 2D and 3D video data in a communication system, in accordance with an embodiment of the present disclosure;

FIG. 6 provides an example data flow diagram of an image processing system to transmit 2D and 3D video data, in accordance with an embodiment of the present disclosure;

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

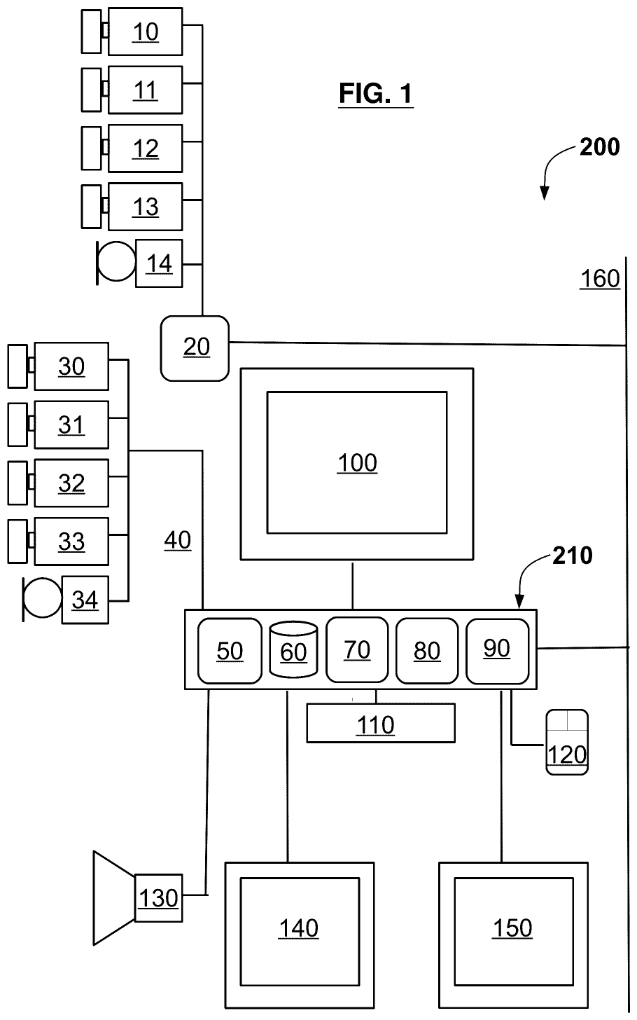

Methods, systems and devices are disclosed to capture Plenoptic video and stereo audio streams and then encode, stream and render in 3D the Plenoptic video, by employing a real-time communication application. This Plenoptic video data may be shown locally or remotely on a Lenticular display such that it appears to the observer as a 3D volumetric rending. An exemplary embodiment of the receiving and/or transmitting 3D volumetric communication system is schematically illustrated in FIG. 1 and is denoted by item number 200.

The device employs an array of one or more cameras, items 10-13 and/or 30-33, as described in FIG. 1. Wherein, each camera contains a single or plurality of sensors providing a plurality of 2D or 2.5D images of a scene, to an image proceeding engine 210. In embodiments, the camera(s) may employ, singly, or in combination; an imaging sensor, a LIDAR apparatus, a structured light apparatus or a stereoscopic capture apparatus, to ingest data suitable for constructing a final 3D view of the current scene.

In one embodiment, the calculation of the final 3D volumetric frame can occur on each of the cameras 10-13 and/or 30-33. These complete frames of RGBD volumetric data, named volumetric primitives, are passed to the image processing engine 210. In another embodiment, a more limited pre-processing occurs, so that only the depth frame is calculated on the camera 10 and/or 30. In this case, synchronised but separate streams of RGB and Depth data are passed to the image processing engine 210. In both cases, these volumetric primitives, are used by the image processing system 210 as described further herein.

In embodiments employing a simpler camera, the capture devices 10-13 and/or 30-33 produces unprocessed video frames which are passed to the image processing system 210. Stereo cameras that create parallax-binocular synchronised video frames are illustrative embodiments of such devices. The unprocessed video may then be used by the image processing engine 210 therein, to compute the final 3D frame, using binocular disparity processing. These raw RGB images or volumetric primitives, in embodiments, are used by the image processing system 210 as described further herein.

In embodiments, a combination of one or more structured light cameras may provide a more accurate depth map (in common co-ordinates), to a further array of simpler binocular cameras to augment these simpler cameras attribution of depth plane location for each of their pixels.

The system also captures an audio stream from a single microphone or array of microphones 14 and/or 34. This stream can be mono, stereo or a further incremental plurality of sound capture origin points.

The camera array 10-13 and microphones 14, can be located within a local area network, in which case communication with the ingest devices occurs over a network 160, usually through a router or hub 20. The ingest devices may also be on the Internet or another public network. The camera array 30-33 and microphones 34, may be attached directly to the computer via a bus 40 (e.g. a USB connection). The cameras 10-13 and/or 30-33 may provide the incoming video streams as frames encoded in a raw pixel format (YUV, RGB24 etc.). Alternatively, the frames received may be compressed as a stream in a common compression format (VC-1, MJPEG, H264 etc.). In the latter case these video streams will need to be decompressed to raw pixel frames in the format considered most convenient prior to processing (to YUV, RGB24 etc.) by the image processing engine. In embodiments this decompression can occur on a single CPU using the instructions provided by a running program or on multiple CPU's, by dedicated hardware chips or parts therein, programmable floating programmable gate arrays (FPGA) chips or co-processors of various types (vector processing units, GPGPU cards etc.). These hardware possibilities are represented schematically in FIG. 1 by item 80. Similar facility is also provided by item 80 for processing audio stream from the microphone/s 14 and/or 34.

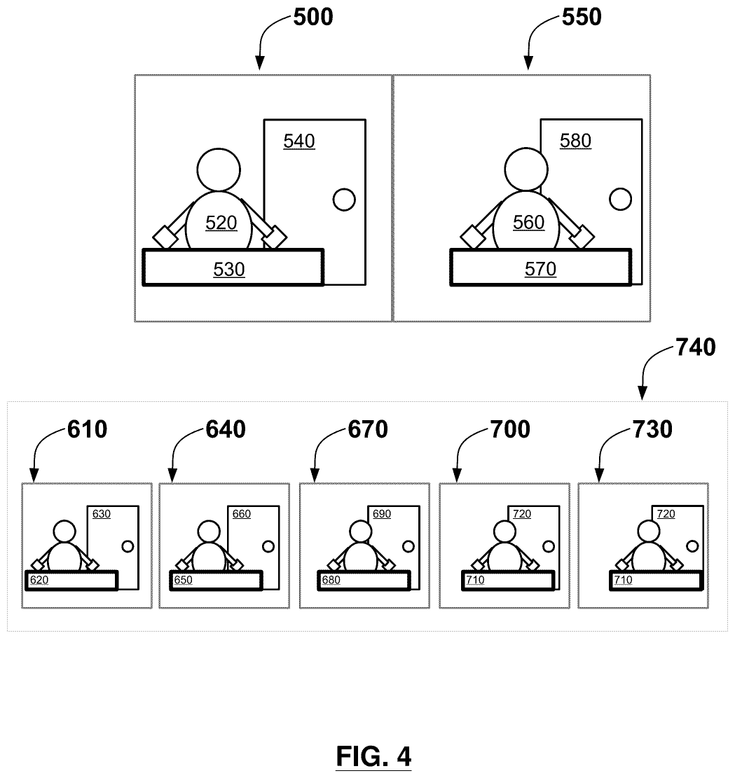

The imaging system 200 includes image processing capability based on a general-purpose computer. The computer has a Processing Unit 70, having access to disk storage 60 (or other computer readable memory) for program and data, a network interface card 90 connected to a network 160 such as an Ethernet Network or the Internet. The modules and software features described herein are, in embodiments, stored in the disk storage (or other computer readable memory) for execution by processing unit 70. In some embodiments, the imaging system 200 includes a single display device or plurality of such devices, including any combination of cathode ray tubes or liquid crystal display and/or lenticular display device 100/140/150 respectively in FIG. 1. A keyboard 110 and a user input device such as a mouse 120 or a touch screen (not shown). The imaging system 200 operates under program control, the programs being stored in the storage disk 60 (or other computer readable memory) and provided, for example, by the network 160, a removable storage disk (not shown) or a pre-installation on the disk storage 60. FIG. 4 illustrates one such exemplary software program to facilitate Plenoptic capture and encoding of 3D volumetric video data into a real-time communication application, in accordance with various embodiments. The imaging system 210 is configured to perform image processing, on an incoming frame or plurality of frames. These calculations can occur on a single CPU using the instructions provided by a running program or on multiple CPU's by dedicated hardware chips, programmable floating programmable gate arrays (FPGA) chips or co-processors of various types (vector processing units, GPGPU cards etc.). These hardware possibilities are represented schematically in FIG. 1 by item 80.

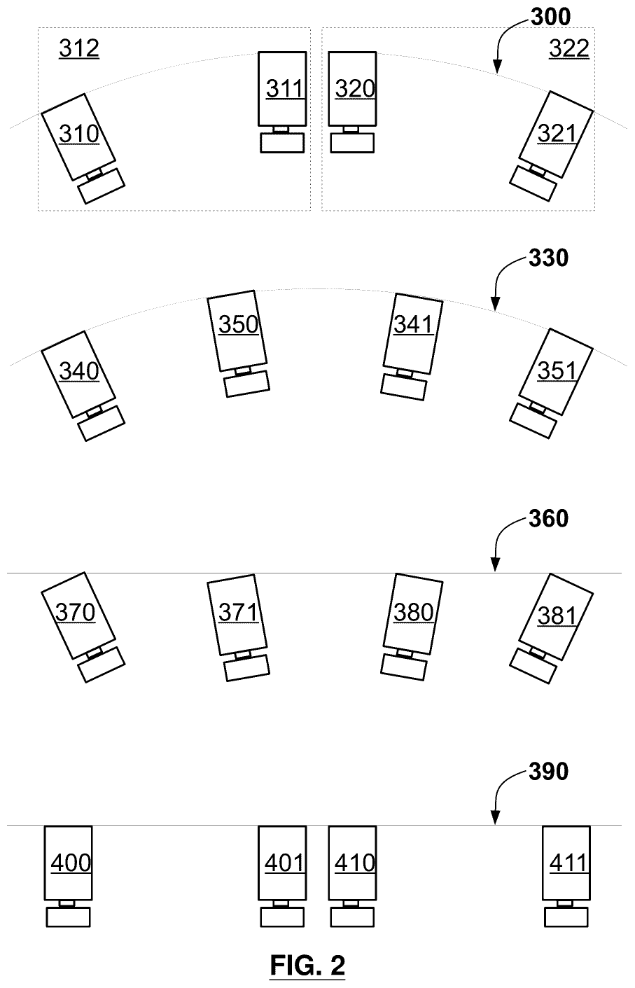

FIG. 2, demonstrates how, in embodiments, the camera array 10-13 and/or 30-33 may be geometrically arranged relative to each other and the subject to optimally capture the scene for rendering in 3D on a Lenticular display.

A lenticular display is a stereoscopic display which is able to display stereoscopic images with a binocular perception of 3D depth, without the use of specialist headset or polarised glasses. Lenticular displays are commercially available for example devices produced by the Looking-Glass Factory. Such displays are advantageous over devices such as Augmented Reality as interaction with the lenticular display is completely natural; as the user changes viewing angle, the view of the object also changes whilst the lenticular display itself is static and multiple users can view the 3D image simultaneously, all from different angles. This technology thus provides an ideal mechanism to render streaming volumetric video and its use in real-time spatial communication. Further information on the use of lenticular displays and 3D volumetric video data is provided in the applicant's U.K. Patent GB2582251B (the contents of which is hereby incorporated by reference).

The individual cameras of the array, 310,311,320 and 321, which in combinations of two or more synchronised sensors (310 & 311, or 320 & 321), comprise a single stereo camera (312 & 322 denoted by dashed line in the figure), are laid out in an arc imitating the observers viewing arc on the lenticular display. In embodiments, this arc of viewing in the lenticular display is ˜45°, so that the angular disparity between the first and last camera (310 and 321) shall match this value. In the geometric arrangement shown the individual cameras are angled such that their frame's centroid hypotenusal distance to the observed subject is as similar as possible for each of the cameras 310,311,320 & 321. As such they are laid out in an arc. In embodiments this is achieved by means of attaching them to an arched rail or within an arched enclosure 300. In embodiments the cameras 310 and 311 are synchronised. The cameras 320 and 321 are also synchronised. Note that cameras 311 and 320 though not synchronized are physically close on the arched rail. This arrangement will be exploited when images from cameras are processed by the image processing engine described below. Camera images captured are rectified and distortions are removed such that cameras exhibit Epipolar lines.

In embodiments the cameras 340, 341, 350 & 351 may be laid out in an alternate geometric pattern to that shown with cameras 310-321. In this case the cameras are evenly distributed around the arched rail 330, but cameras 340 is synched with 341 and 350 is synched with 351. This creates an interleaving of synchronised cameras.

In FIG. 2, 4 cameras are each attached to rails 300, 330, 360 and 390. This arrangement is intended to provide an illustrative, schematic representation and in embodiments the number of cameras in the array's is most likely to be more numerous.

In embodiments the rail or enclosure 360, guiding the location of the cameras may not be an arc but may rather be straight. The cameras in the array 370,371,380 & 381 may also be angled in an arc to capture the field of view for lenticular display, however in this case, the hypotenusal distance to the subject will not be identical across all the cameras and so this must be mitigated for by the imaging system 210 scaling images so that the subject is at identical dimensions from each camera. In embodiments the synchronized cameras may be located side by side or interleaved as described above. Finally, in embodiments the camera array 400,401,410 and 411 may be arranged to be parallel to the straight rail 390. In this case both the angle to the subject and the distance to the subject must be accommodated by the imaging system 210 in order to provide a satisfactory volumetric image to the Lenticular display 150.

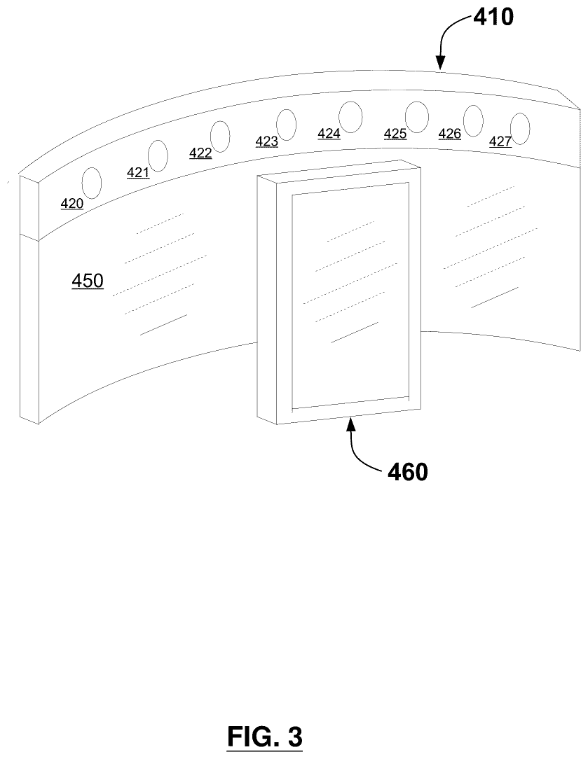

FIG. 3 schematically presents an embodiment of the system in which the array 410, of geometrically arranged cameras 420, 421, 422, 423, 424, 425, 426 and 27 are arranged atop a secondary display 450. The lenticular display 460 is positioned in front of the secondary monitor 450. In embodiments cameras 420 and 427 capture a wide angled view of the scene. These views are then stitched together by methods well-known to One skilled in the art and transmitted to a remote computer. The partner/remote computer then displays a live, captured, panoramic background scene on the secondary monitor 450, whilst the frontal lenticular display renders the 3D volumetric scene, also transmitted from the same remote partner computer. Empirically, the employment of an additional background panoramic display has the effect of deepening the depth perception ascribed to the lenticular display. The 3D effect observed by the foveal processing for the immediate field of vision in the lenticular display spills over into the panoramic display, which is providing scene contextualised and relevant visual cues to the peripheral vision thereby enhancing the depth perception of the foveal vision applied to the lenticular display. Thus, the 3D effect of the overall system is far more pronounced than using a Lenticular display alone.

Further, when viewed in combination, these two displays producing a more profound sense of overall space and we speculate that the brain's visual system may be deriving this sense of space from the physical separation between the two displays. This spatial enhancement is even more pronounced when the panorama being shown is dynamic and moving. We believe that the addition of a secondary monitor in 3D “real-world” space is a novel and inventive step providing significant advantage.

In embodiments the secondary screen 450 may instead be a further lenticular display with a greater dimension than the display 460.

In embodiments the camera array 410 may rest atop the lenticular display 460 or may be entirely separate from either display.

In embodiments the panoramic background displayed on secondary display 450, may be constructed by image stitching RGBD images together derived from binocular cameras 421-426, in which “background” pixels from the RGBD image having a greater depth (Z plane distance from the cameras), than a defined threshold value (usually equating to the typical location of the human subject), are extracted and stitched into the panoramic image.

In embodiments the panoramic background view may be transmitted from the ingesting computer to the rending computer by sequentially adding these images into the geometrically laid out frames that shall be encoding prior to transmission. In effect the panoramic frame is just another array of pixels within the frame that may, on decoding by the remote computer, be rendered to the secondary display. In alternative embodiments the panoramic images are encoded within their own media stream narrowcast to the remote computer, which may then decode and rend this stream to the secondary display.

The lenticular display 150, works flawlessly, producing fully immersive 3D images when displaying a dense fan of views, with each view rotated about the subject by ˜1.5 degrees or less. When the fan of views is less dense than described a discontinuity or “jump” is observable between views as the viewer moves their head around the subject shown in the lenticular display, breaking the immersive illusion. In embodiments, the lenticular display 150 provides up to a 45° field of view on the subject, implying the requirement of using some 30 or more monocular censored cameras to achieve said required density of camera views to maintain an immersive view of the subject on the lenticular display 150. Indeed, such systems have been demonstrated and represent the “state of the art”, however, they are implicitly unwieldy and require complex bus interfaces to transfer data onto the host computer from so many peripheral camera devices and large network bandwidths to transmit concomitantly prodigious volumes of data. Thus, in embodiments, the use of stereo cameras over mono sensor cameras is favoured, since the stereo cameras only use a single USB cable to capture data from 2 camera sensors thus halving the number of physical USB ports that the hosting computer fills with connected cameras. USB ports are a limited resource on each computers motherboard and so halving the number required is manifestly advantageous. Recent years have seen USB cable connections become much more stable and robust to hot swapping device in and out of the hosting computer. However, the USB connected devices response to hot swapping or power cycling are still dependant on manufacturer implementation and some are better than others at providing an error tolerant implementation. Thus, reducing the number of cameras connected to the hosting computer often reduces the chance of connection failure through the USB bus malfunction.

One skilled in the art would know that it is possible to construct a stereo disparity image from the rectified images from the 2 synchronised cameras. This image roughly representing the shared midpoint view of the two cameras. In FIG. 4, the stereo synchronised cameras capture two frames simultaneously, from left 500 in the upper portion of the diagram and 610 in the lower fan of images, 740. The right image is enumerated as 550 in the upper portion of the diagram and 730 in the fan 740 below. The upper images 500 & 550 have undergone image processing to construct the RGBD disparity image 670. Note that in 500 and 610 the human subject 520, behind the desk 530 abuts the left-hand side of the image whilst the door 540, is located in the background of the image. In the right-hand image 550& 730 the door moves to the right, but this movement is more pronounced for the foreground objects 560 and 570 being the human subject and desk respectively. This shifting of objects is typical for a disparity image and it is precisely the observation that allows the depth of the objects in question to be calculated for a patch of pixels in the disparity, RGBD, image 670.

In embodiments, if the camera capturing image 500 and the camera capturing image 550 are separated by a anthropomorphic interocular distance and the angle between the cameras differs by 5° in the horizontal plane, then in image 670 the human subject, desk and background door are mid-way between their locations in images 500/610 and 550/730 and the image is at 2.5° rotation in the x plane from both image 500 and 550. Since the disparity image also has a calculated depth component it is possible to change the camera view in computer space on the disparity image 670 to left and right by fractions of a degree to yield images 640 and 700 respectively, each sitting at the mid-point of 1.25° from the real captured frame and the central RGBD disparity frame 670. Empirical evidence demonstrates that these new synthetic frames are close enough to the original viewports to neither have observable pixels misaligned by wrongly attributed Z locations nor obvious novel reflected rays with high albedo. Rather by finding the appropriate geometric shift of pixels in 2.5D space we create synthetic frames that completes the fan of images with each equidistant and separated by a 1.25° to the next, 610,640,670,700 and 730 and can be successfully displayed in the Lenticular display 150. In embodiments a plurality of abutting fans 740 derived from a plurality of abutting stereo cameras, may be rendered in the lenticular display to create a continuous 3D image around the entire 45° observable arc from just 9 stereo cameras rather than the 30 or more mono cameras that represent the current state of the art.

In embodiments, the original views 500 and 550 may be captured by one or more structured light device (or LIDAR device). The attribution of Z distances in images from these devices is often superior to that achieved by binocular disparity searching, which may have gaps in the Z plane attribution for some pixels. Thus, the RGBD depth image of the scene captured by structured light device can be used to augment the depth data on the simple binocular stereo cameras present in the array. If both simple camera and the structured light camera have the same co-ordinate system and the intrinsic and extrinsic parameters of each are known then mapping the view of one camera to another is possible, in which case the depth values derived from the structured light camera may augment those from the binocular camera. This process is often named “Registration” and one skilled in the art would know that several methods are available to achieve this end. In embodiments, this is achieved by rending the point clouds from the structured light cameras in a games engine or OpenGL equivalent and emulating the intrinsic and extrinsic parameters of the simple camera into the virtual camera that is viewing the RGBD point cloud of the scene. The resultant virtual RGBD image may be captured and each RGBD pixel from this synthetic scene attributed to the simple camera view by lookup. Some pixels in the simple camera synthetic frame will have neither their own Z location nor a Z location found in the game engine rending (they were hidden behind a foreground object in the view of the structured light camera). Such pixels can be attributed a Z value from a simple algorithm such as an averaging function of local Z locations achieved by a convolution filter passed over an image masked with known locations; one skilled in the art would know that other algorithms are available to achieve the same end.

In embodiments, it would be possible to increase number of synthetic frames 640 and 700 present in the arc 740, to create a denser volumetric representation of the scene to pass to the rending lenticular display. Further that the density of these frames could also be variable both within the arcs themselves and also between arcs. Thus, in embodiments the central arc 740 displayed on the lenticular display would have a higher density of synthetic frames than those towards the outside of the displayed arc. This is because the outside images are less likely to be observed than the inner images by viewers of the lenticular display in a given timeframe.

Further, if the hardware dependant but invariant rectification matrix between the cameras capturing views 500 and 550 is known to a remote computer then it is possible to construct the fan of multiple views 740 whilst only transmitting the two views 500 & 550 to the remote computer. This dramatically reduces the quantity of data to be transmitted over a network for the partner computer to effectively render each fan in the lenticular display. In embodiments, the remote computer rending the arc may retrieve the rectification matrix of the cameras ingesting the scene from a central repository such as a database using a unique identifier provided by the transmitting computer to the rending computer. Alternatively, the transmitting computer may send this data to the rending computer via a “side”, data channel or as the first N frames in the compressed video stream.

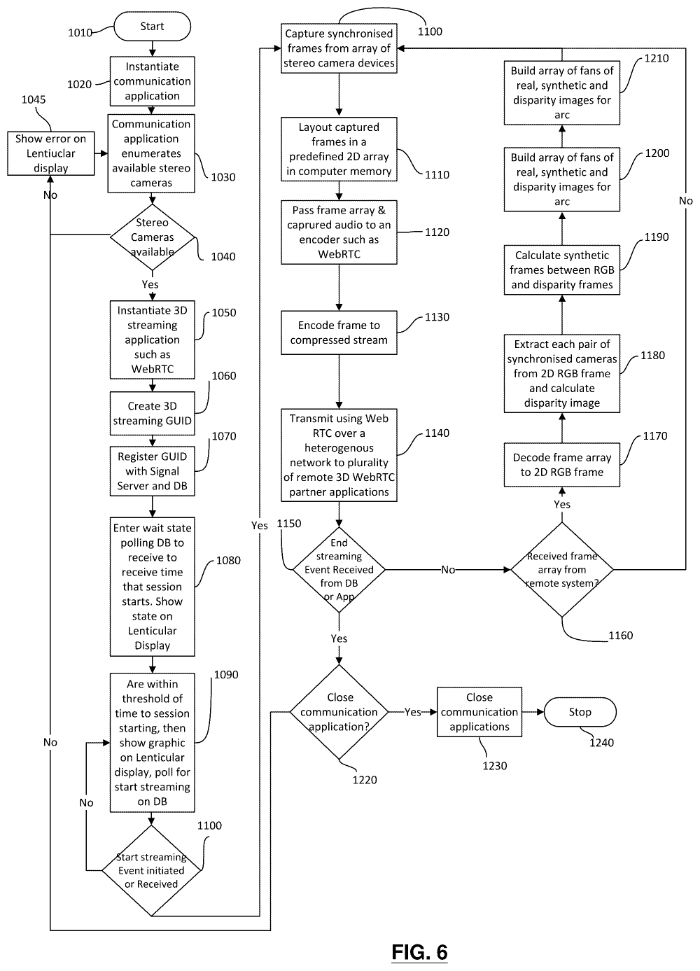

Video data is notoriously voluminous and concomitantly hungry for network bandwidth. Any usable video communications application must thus provide a mechanism to compress the video data prior to transmission over a network. It is tempting to construct some exotic and highly specific algorithm to compress the 3D video data, however this is far from a trivial task and the same effect can be achieved by repurposing a 2D video compression algorithm to compress frames of Plenoptically captured data in which the pixels have been laid out according to a specific geometric pattern using a specific algorithm, step 1130 in FIG. 6. For instance the captured frames 500 & 550 from FIG. 4 may be derived from cameras 421 and 422 in FIG. 3. Cameras 422 through 426 also produce similar images so that in total some 6 images are created to be laid out into a 2D frame in a predefined geometric pattern prior to compound image compression and transmission. Optionally, the panoramic image may also be added to the 2D frame. Further, the RGBD image from the structured light camera, if present, would also need to be geometrically laid out into the encoded frame for transmission to the remote computer and we have previously discussed methods to achieve this particular end in our previous Patent. The rending device upon receiving the compressed video bitstream can then decompress the stream to frames and reversing the layout algorithm, reconstruct the 3D video images and optional panoramic and structured light images ready to be rendered, steps 1170, 1180 1190 and 1200 in FIG. 6.

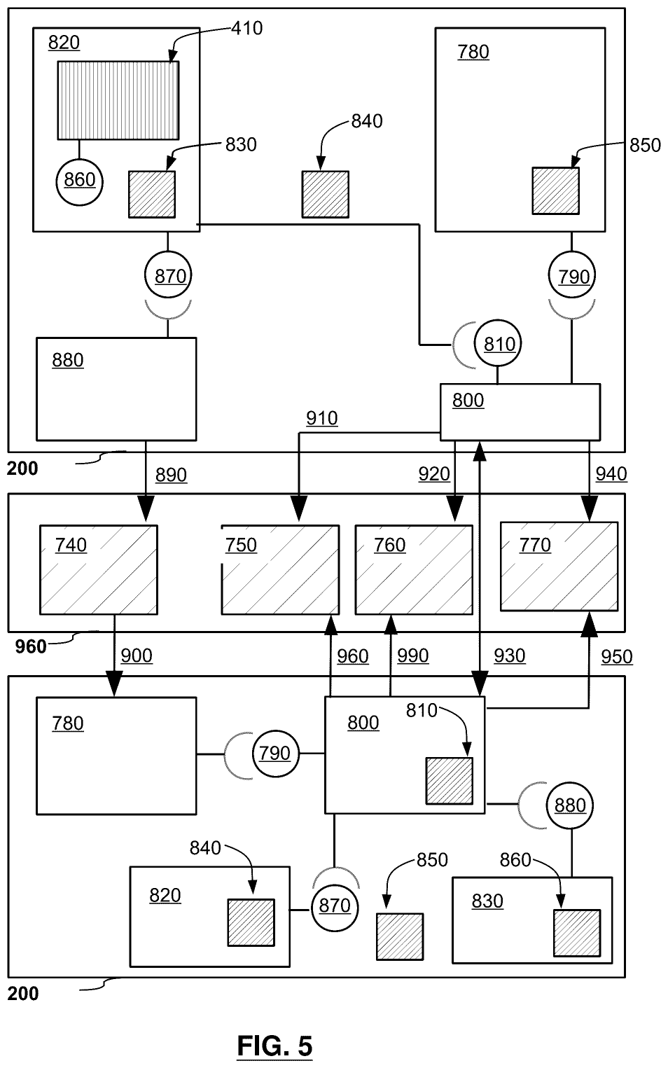

The WebRTC protocol was designed to provide an alternative to the incumbent commercial communication and conferencing applications. As such, it provides an excellent mechanism for compressing and transmitting 2D video data and in embodiments, supported by the correct functional network architecture (Signalling Server 750, TURN server 760 & User Interface server 770 in FIG. 5), WebRTC also provides online presence and communication protocol data and can stream media between users on heterogenous networks. Further, the mechanisms to negotiate the communication across the heterogenous networks occur automatically and so requires no user set up. The WebRTC protocol provides an ideal method to stream 3D video captured by the stereo sensor array 410 over a heterogenous network. However, WebRTC, as a real-time conferencing communication protocol is focused on ingesting 2D media data from a web camera, and then compressing and transmitting this data. By providing a virtual web camera adapter module 780 in FIG. 5, containing the data from all the devices in the stereo camera array (with frames laid out by the image processing engine in a 2D geometrically consistent manner amenable to compression, as described herein and step 1110 in FIG. 6), we may automatically compress, (step 1130 in FIG. 6), and transmit 3D video over heterogenous networks (step 1140 in FIG. 6). The virtual web camera 780 has an API 790 (in FIG. 5), wherein it may by discovered, instantiated and controlled by the hosting WebRTC streaming application 800. Thus, employing a virtual web camera repurposes the WebRTC protocol to transmit stereo data over heterogenous networks.

In modern computer systems, the security of running code is paramount and so sharing data between processes' is restricted. Thus, a method is required to allow the stereo camera array 410 to pass the stereo primitives generated, to the virtual web camera adapter 780. In an exemplary embodiment, the stereo primitives data 830, is copied by the adapter 820, to a shared memory file 840, that is accessible to more than one computer process (i.e. in globally accessible RAM memory). The virtual web camera 780, may then take its own copy of this stereo primitive 850, whereupon it provides this data through the API 790 to the WebRTC streaming application 800, which ingests, compresses and transmits this video. One skilled in the art would recognize that this is one but one embodiment and that other software architectures could be envisaged to allow the stereo primitive video frames to be shared using other methods of inter-process communication (e.g. pipping data between processes, TCP/IP sockets, etc.).

In embodiments, a user wishes to communicate employing a 3D video stream with a remote user. An example of such a wish may be to participate in a Telepsychiatry session. The user instantiates the communication application 880 in FIG. 5, denoted as step 1020 in FIG. 6. The instantiated communication application quizzes the operating system to enumerate all registered web cameras, step 1030 in FIG. 6. Upon instantiation of the array of stereo cameras 820 by the communication application module 880, the WebRTC streaming application 800 is instantiated, which in turn instantiates an instance of the virtual web camera 780. This is denoted as step 1050 in FIG. 6. The WebRTC streaming application module generates a Globally Unique Identifier (GUID) for this instance of its instantiation, step 1060 in FIG. 6. The WebRTC application proceeds to establish if it can communicate with the Internet 910 in FIG. 5, by registering its instance with the remotely hosted WebRTC signal server 750 and the communication application 880 communicates with a remote Database 740 using communications channel 890 to register an instance GUID with the database. This step is denoted by step 1070 in FIG. 6.

In embodiments, the first user (in Telepsychiatry applications this user would have the role of the Patient), will now have to wait for the second user, the Clinician, to initiate the next steps in the video call. Thus, they are placed into a virtual waiting room item 1080 in FIG. 6. During this wait period the Lenticular display and/or panoramic second display shall render a soothing graphic and play an audio cue. Since both the Clinician and patients time are valuable, they will usually have arranged to conduct their video conference at a specific time and this time will be registered in the Database 740. During this waiting period the communications application 880 shall poll the Database 740 at scheduled intervals to determine if the current time is within a specified threshold of the conference start time, item 1080 in FIG. 6. If the current time is within the specified threshold, then the displays show a different graphic and audio.

The second user, the Clinician, then initiates a Video call using the communication application module 880, step 1100 in FIG. 6. The state of the current call is updated in Database 740 and the first user is notified of this event by the instantiated communication application module 880 in FIG. 5 so that the request to communicate is accepted by the first user of program module 880 and bidirectional video communication is established between the computers in a conventional manner, with the communication program 820 providing a 3D video stream from the web camera 780 (step 1110 in FIG. 6), and streaming (step 1140 in FIG. 6), this to the second, remote communications program 880 over a direct communications channel 930.

In embodiments, the direct communications channel 930 may not be able to be established, due to the heterogenous nature of the intermediate network connection, in this case the WebRTC protocol will further attempt to establish a connection employing the Turn Sever 760 relaying data through the communications channels 920 and 990.

One skilled in the art would recognize that the exemplary nature of the method of establishing WebRTC communication between the two program modules described above and that other methods are available providing a method of establishing this communication that would appear more seamless to the user.

FIGS. 3, 4 & 5 further discloses the spatial communication system 200 described in the foregoing, in accordance with one embodiment. The volumetric communication system 200 is disclosed in terms of modules, data processed thereby and some hardware elements. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. It will be understood that sub-modules and modules can be alternatively sub-divided or combined and the shown arrangement is merely by way of example.

In embodiments the remote application 800 now receives 3D volumetric video data in a compressed stream. This stream is decompressed to sequential and individual frames (step 1170 in FIG. 6). These frames consist of known geometric layouts of the images captured from the stereo cameras (stereo primitive images) and optionally the panoramic cameras. The images, are, in embodiments, used in rending as described further herein.

In embodiments, the WebRTC application 800 in FIG. 5, instantiates the program code module 830, to sequentially render the volumetric frames employing the OpenGL graphics language application or a games engine. In one embodiment, the OpenGL code or games module ingests the received stereo camera derived primitive images 500 and 550 from the remote computer. It then may optionally correct these images with the partner computers downloaded rectification matrix and then optionally run a disparity matching algorithm on these two (or more) frames to create the disparity (RGBD) frame, item 1180 in FIG. 6. The stereo primitive images and optional RGBD frame is then encoded in computer memory, wherein one OpenGL Quad Vertex objects represents a single pixel within each frame. The Vertex is placed in 3D computer space to be of the correct X and Y location for the stereo primitive image and the correct X, Y and Z location, to match the pixel's location in the optional RGBD image and these vertexes are coloured to match the RGB value of the pixel. Upon completion of the specification of all pixel locations and colours a virtual camera is pointed at the pixels of the stereo camera images and optional disparity image rendered in computer space, as a means to capture a further display image with the attributes of the specified location, angle and FOV of the virtual camera. The attributes of the virtual camera, when pointing at the Disparity RGBD image may be further altered by rotating the camera around the X plane to create synthetic images between the stereo camera images and the frontal view of the RGBD image. All the images are then cropped to the same size, since RGBD based images will have bands on the left and right edges where the pixels in one stereo pair have no match in the second stereo pair. These images are written to computer memory, item 1200 in FIG. 6. The 2D RGB captured frames, and optional RGBD disparity frame and synthetic frames, are then copied to a further piece of computer memory acting as a quilt that is rendered by the Lenticular array, item 1210 in FIG. 6. In embodiments, prior to display, the images are upscaled by Deep Learning Super-scaling methods such as the “The Super Resolution Filter” provided by Nvidia in their Maxine SDK.

In embodiments the module receiving the 3D video stream 800, relay's it's state (e.g. new stream about to be received or user wishes to end connection), to the program module 830 that renders graphics in the lenticular display using the API 880. Upon receiving the state change the rending application can look up the appropriate 3D animation from a library of such animations, to inform the user of the state change. In embodiments, the animation may comprise a file containing multiple frames of volumetric data that have been precalculated, to be read into memory and then run as an animation, or the volumetric rending to display can be calculated on the fly by program submodules of the game engine.

FIGS. 3, 4 & 5 further discloses the spatial communication system 200 described in the foregoing, in accordance with one embodiment. The volumetric communication system 200 is disclosed in terms of modules, data processed thereby and some hardware elements. As used herein, the term module refers to any hardware, software, firmware, electronic control component, processing logic, and/or processor device, individually or in any combination, including without limitation: application specific integrated circuit (ASIC), an electronic circuit, a processor (shared, dedicated, or group) and memory that executes one or more software or firmware programs, a combinational logic circuit, and/or other suitable components that provide the described functionality. It will be understood that sub-modules and modules can be alternatively sub-divided or combined and the shown arrangement is merely by way of example.

While at least one exemplary aspect has been presented in the foregoing detailed description of the invention, it should be appreciated that a vast number of variations exist. It should also be appreciated that the exemplary aspect or exemplary aspects are only examples, and are not intended to limit the scope, applicability, or configuration of the invention in any way. Rather, the foregoing detailed description will provide those skilled in the art with a convenient road map for implementing an exemplary aspect of the invention. It being understood that various changes may be made in the function and arrangement of elements described in an exemplary aspect without departing from the scope of the invention as set forth in the appended claims.

1. A real-time spatial communication apparatus, the apparatus comprising:
an imaging system comprising a plurality of stereo imaging sensors configured to capture video data comprising a plurality of plenoptic frames of a scene;
a display system comprising a lenticular display; and
an image processing system comprising a processing unit, a computer readable memory, and a network interface; processing unit being configured to:
receive captured video data from the imaging system, encode the captured video data and transmit the encoded captured video data via the network interface; and
receive remote video data from the network interface; decode the remote video data and display spatial video on the display system.

2. The real-time spatial communication apparatus of claim 1, wherein the imaging system comprises at least one time of flight/structured light sensor for capturing a 3D point cloud.

3. The real-time spatial communication apparatus of claim 1, wherein the plurality of stereo imaging sensors are arranged as an array with each individual stereo imaging sensor spaced apart along a housing of the apparatus.

4. The real-time spatial communication apparatus of claim 1, wherein the display system further comprises a secondary display and wherein the image processing system is further configured to render the received video data as a 3D subject scene on the lenticular display and a 2D background scene on the secondary display.

5. The real-time spatial communication apparatus of claim 4, wherein the secondary display is larger than the lenticular display.

6. The real-time spatial communication apparatus of claim 4, wherein the secondary display is a curved display, the curved display having a concave viewing surface and wherein the lenticular display is aligned with a central axis of the viewing surface.

7. The real-time spatial communication apparatus of claim 4, wherein the image processing system is configured to extract the 2D background scene from a volumetric scene based upon pixels having a depth value which exceeds a threshold value.

8. The real-time spatial communication apparatus of claim 1, wherein the image processing system compresses the video data for transmission by geometrically arranging 3D video data on a 2D frame prior to application of a 2D video compression algorithm.

9. The real-time spatial communication apparatus of claim 1, wherein the apparatus further comprises an audio system comprising at least one speaker for outputting audio and at least one microphone for capturing audio.

10. The real-time spatial communication apparatus of claim 1, wherein the image processing system is configured to encapsulate the captured video data from the plurality of imaging sensors as a virtual web camera.

11. The real-time spatial communication apparatus of claim 10, wherein the image processing system geometrically arranges RGBD data derived from the imaging sensors into a 2D frame.

12. An apparatus for real-time spatial communication, the apparatus comprising:
a lenticular display for displaying 3D volumetric video of a subject during real-time spatial communication;
a secondary display positioned with a viewing surface behind the lenticular display for displaying a background image.

13. The apparatus for real-time spatial communication of claim 12, wherein the apparatus further comprises an imaging system for capturing video data, the imaging system comprising a plurality of stereo imaging sensors configured to capture a plurality of plenoptic frames of a scene.

14. The apparatus for real-time spatial communication of claim 13, wherein the plurality of stereo imaging sensors are arranged as an array with the individual stereo imaging sensors spaced apart along a housing of the apparatus.

15. The apparatus for real-time spatial communication of claim 12, wherein the secondary display is a curved display, the curved display having a concave viewing surface and wherein the lenticular display is aligned with a central axis of the viewing surface.

16. A method of real-time spatial communication, the method comprising:
capturing 3D volumetric video of a scene at a first location;
transmitting the 3D volumetric video over a network;
receiving the 3D volumetric video from the network at a second location; and
rendering the 3D volumetric video simultaneously as a 3D subject on a lenticular display and a background on a secondary display.

17. The method of real-time spatial communication of claim 16, wherein capturing 3D volumetric video comprises capturing 3D volumetric video using an array of stereo sensors and the 3D volumetric video comprises data from a plurality of stereo sensors forming the array.

18. The method of real-time spatial communication of claim 16, further comprising the step of extracting the background from the 3D volumetric video by extracting pixels having a depth value which exceeds a threshold value.

19. The method of real-time spatial communication of claim 16, further comprising the step of encoding the 3D volumetric video prior to transmission over the network and wherein the encoding step comprises arranging frames of 3D data in a specific geometric pattern on a single 2D frame and using a 2D video compression algorithm to encode the resulting data.

20. The method of real-time spatial communication of claim 16, wherein rendering a 3D subject on a lenticular display comprises rendering a fan of frames each rotated about the subject by an incremental angle and wherein the method further comprises generating synthetic frames at intermediate angles between frames captured in the 3D volumetric video.
